(19) United States
(12) Patent Application Publication
(10) Pub. No.: US 2005/0187886 A9
(43) Pub. Date: Aug. 25, 2005

(54) Systems and methods for mid-stream postage adjustment

(76) Inventors: Vantresa Stickler, Annapolis, MD (US); John R. Phillips, Atlanta, GA (US); Donald McPherson, Billings, MT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/630,589

(22) Filed: Jul. 29, 2003

Related U.S. Application Data
(60) Provisional application No. 60/407,582, filed on Aug. 29, 2002.

(51) Int. Cl. G06F 17/00

(52) U.S. Cl. 705/402; 705/404

(57) ABSTRACT

A method and system for receiving payment for postage by a delivery system operator from a customer is provided. The method includes receiving payment from the customer for a first postage value; receiving the parcel for delivery, the parcel including a machine-readable postage indicia indicating the amount of the received payment; determining parcel attributes; calculating a determined postage value for the parcel based on the determined parcel attributes; determining the first postage value from the indicia; and transmitting a postage payment adjustment amount based on a comparison between the first postage value and the determined postage value.

### RELATED APPLICATIONS

Under provisions of 35 U.S.C. § 119(e), the Applicant claims the benefit of U.S. Provisional Application No. 60/407,582, filed Aug. 29, 2002, and incorporated herein by reference.

This application is related to an application entitled PC Postage™ Service Indicia Design For Shipping Label bearing attorney docket number 07451-0924.00000 filed on the same date as the present application, the contents of which are incorporated herein by reference.

### TECHNICAL FIELD

The present invention relates to the field of postage. More particularly, in various specific embodiments, it involves methods and systems directed to providing a postage adjustment system.

### BACKGROUND

The United States Postal Service (USPS) is an independent government agency that provides mail delivery and other services to the public. The USPS is widely recognized by individual customers as a safe and reliable means for sending and receiving parcels through a physical mail stream.

Many customers seek greater convenience in sending parcels. They wish to prepare parcels, such as packages and other items of various sizes, shapes and weights, without having to visit a delivery system operator. These include the USPS™, Federal Express (FEDEX™), or United Parcel Service (UPS™). Customers may wish for the flexibility of mailing a parcel from home, without the burden of a face-to-face postage purchase. Yet customers do not want the inconvenience of underpaying for a parcel and having it returned, or overpaying for a parcel and not receiving credit for the overpayment. Both of these inaccurate payments stem from customer misestimates of the size and weight of a parcel.

On the Internet, customers now are able to access information and computer application programs (“applications”) for generating postage, using standard computer equipment, such as a personal computer with a display and a connection to the Internet. Typically, they access information using a computer program called a “web browser,” which provides an interface to the Internet. Examples of web browsers include Netscape Navigator™ from Netscape Communications Corporation or Internet Explorer™ from Microsoft Corporation. Using a web browser, customers can access an application for generating postage, such as PCPostage™, Click-N-Ship™, and Global Express Guaranteed™ available on the USPS web site (http://www.usps.gov). However, the application for generating postage does not provide confirmation that the customer's estimate of dimension and weight of a parcel is accurate.

Thus, there is a need for delivery system operators to efficiently provide for the adjustment of postage value. More specifically, delivery system operators desire to efficiently provide credit or debit of overpayment or underpayment of postage amounts. In an increasingly competitive environment, it is essential for delivery system operators to reduce costs and exceed the expectations of those who receive a service. Thus, there exists a need for efficiently providing postage value adjustment in the physical mail stream.

### SUMMARY OF THE INVENTION

In one aspect, a method for receiving payment for postage by a delivery service provider from a customer is provided. The method includes receiving payment from the customer for a first postage value; receiving the parcel for delivery, the parcel including a machine-readable postage indicia indicating the amount of the received payment; determining parcel attributes; calculating a determined postage value for the parcel based on the determined parcel attributes; determining the first postage value from the indicia; and transmitting a postage payment adjustment amount based on a comparison between the first postage value and the determined postage value.

In another aspect, a method for receiving payment for postage by a delivery service provider from a customer is provided. The method includes receiving from the customer mailing information for a parcel, the mailing information comprising customer-determined attributes of the parcel; calculating a first postage value based on the customer-determined attributes; transmitting data to the customer to permit printing by the customer of a mailing label for the parcel, the mailing label including an indication of the first postage value; charging a customer account for the first postage value; determining attributes of the parcel by the delivery system operator; calculating a second postage value for the parcel based on the actual attributes; and transmitting a postage payment adjustment amount to the customer account based on a comparison between the first and second postage values.

In yet another aspect, a system for correcting a postage value is provided. The system including a memory having program instructions; and a processor responsive to the program instructions to: storing a first postage value derived from customer-determined attributes of a parcel; receiving payment for the first postage value; generating a second postage value based on attributes of the parcel determined by the delivery system operator; comparing the first and second postage values; providing a credit to the customer if the first postage value is greater then the second postage value; and generating a charge to the customer if the second postage value is less then the first postage value.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of the physical mail stream for providing parcel delivery, consistent with an embodiment of the invention;

FIG. 2 is a functional block diagram of a system for providing postage adjustment, consistent with an embodiment of the invention;

FIG. 3 is a functional block diagram of an exemplary computing system, consistent with an embodiment of the invention;

FIG. 4 is a graphical depiction of an exemplary Internet interface for displaying an application for generating a mailing label with a postage value, consistent with an embodiment of the invention;

FIG. 5 is a functional block diagram of an exemplary transaction record, consistent with an embodiment of the invention;

FIG. 6 is a graphical depiction of an exemplary mailing label, consistent with an embodiment of the invention; and

FIG. 7 is a flow chart of an exemplary method for providing postage adjustment, consistent with an embodiment of the invention.

### DETAILED DESCRIPTION

Reference will now be made to various embodiments consistent with this invention, examples of which appear in the accompanying drawings and will be obvious from the description of the invention. In the drawings, the same reference numbers represent the same or similar elements in the different drawings whenever possible.

When a customer intends to send a parcel and does not wish to visit a delivery system operator to purchase postage, the customer may use an Internet application to generate and purchase postage. The customer may determine parcel attributes, such as height, length, and width, and the weight of the parcel, either by measurement or estimation. Using the determined dimensions and weight, the Internet application calculates postage and produces a mailing label. The customer prints a mailing label, which includes the customer-determined postage value, at his location and attaches the label to the parcel before depositing it into the physical mail stream.

At a designated Point-of-Service (POS) in the physical mail stream, the delivery system operator determines the attributes (dimensions and weight) of the parcel, in order to generate a required postage value. If the customer-determined dimensions and weight are accurate, the customer-determined and operator-determined postage values are the same, and the parcel can continue its path through the physical mail stream to the destination. If there is a discrepancy between the customer-determined and operator-determined postage values, the customer's account may be credited or debited with a postage payment adjustment amount, and then the parcel may continue its path through the physical mail stream.

Embodiments of the present invention may be implemented in connection with various types of computing devices. By way of a non-limiting example, an exemplary implementation will be described with reference to use of a computer system. As those skilled in the art can appreciate, embodiments of the invention can be implemented in many types of computing systems, such as desktop system, laptops, PDA's, mobile phones, settop boxes, thin-client devices, and/or any computing devices that have network access. The computing device can also be a specifically designed device.

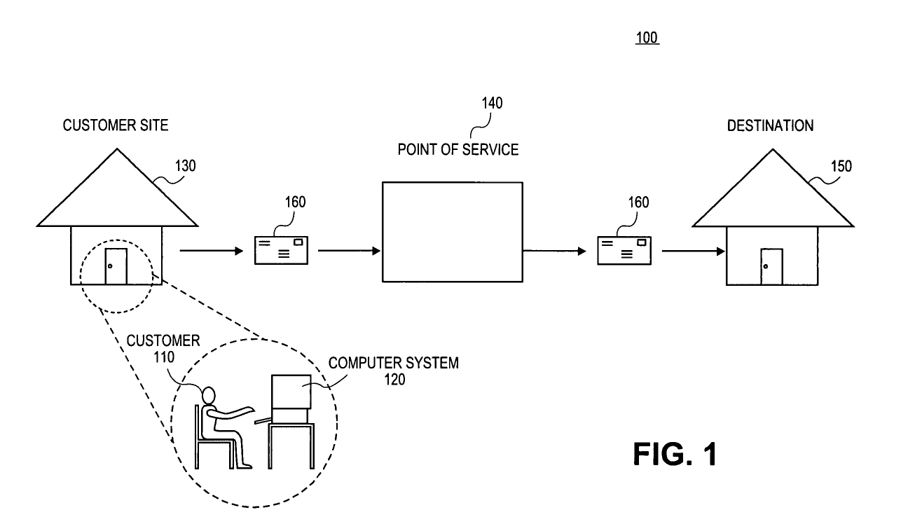

FIG. 1 depicts a functional block diagram of a system for providing parcel delivery with postage adjustment. At a customer site 130, a customer 110 uses a computer system 120 to connect via the Internet to an application for generating postage. Using information entered by customer 110, the application generates a label including a postage value for a parcel 160, which can be printed on system 120. The postage value may be indicated through a machine-readable postage indicia on the label that indicates the amount of payment. In an alternate embodiment, the printed label may include only the postage value, and customer 110 may physically enter address information onto the label. Customer 110 may be at a site 130 remote from an authorized delivery system operator, such as a home, an office, or other remote site. Customer 110 then places parcel 160 in the physical mail stream at a delivery system operator.

While in the physical mail stream, leading from customer site 130 to destination 150, parcel 160 passes through a Point-of-Service (POS) 140. At POS 140, the parcel can be evaluated to determine if the customer-determined postage value was accurate. Parcel 160 may be a United States Postal Service Priority Mail package, a United States Postal Service Express Mail package, Global Express package, Global Express Guaranteed package, odd-sized package, or other package or item.

POS 140 may utilize a weighing and image capturing system to determine attributes of parcel 160. Parcel 160 is passed through weighing and image capturing system to determine the weight of parcel 160, to obtain the image of parcel 160, and to determine physical dimensions, such as thickness, of parcel 160. In one embodiment, weighing and image capturing system may comprise a video camera, an in-line scale, a thickness sensor, and a weighing and image-capturing server. While a video camera, an in-line scale, and a thickness sensor may be utilized to determine the image, weight, and physical dimension of parcel 160 respectively, those skilled in the art will appreciate that may other devices may be utilized to obtain this data. With the image, weight, and physical dimension of parcel 160 obtained, this data may be stored in dimension weight record for parcel 160. In an alternate embodiment, the height, width, and length of parcel 160, along with other information about parcel 160 may be measured.

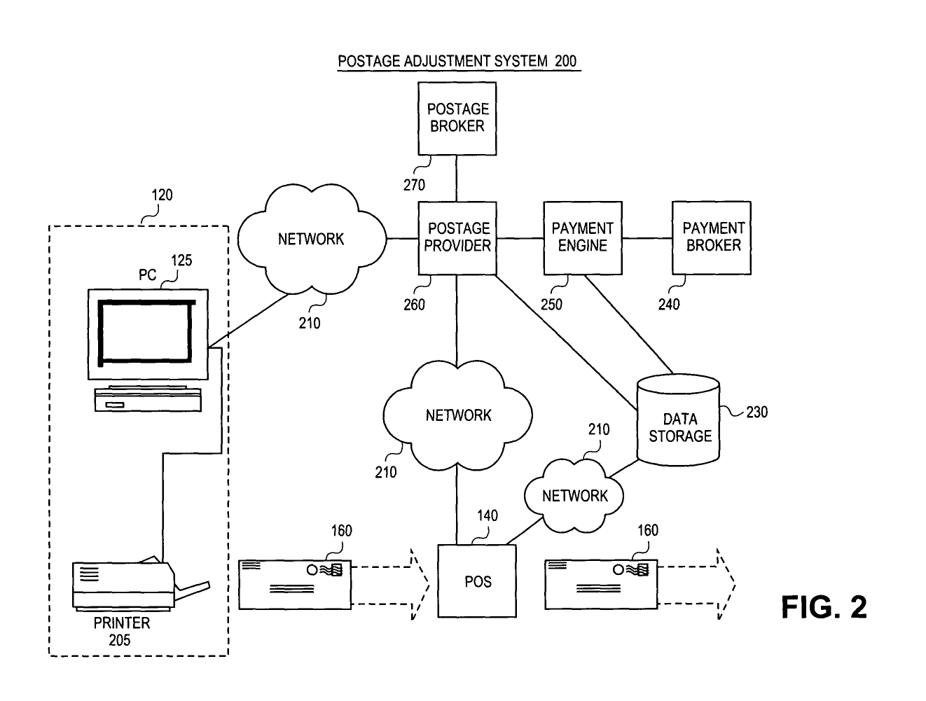

FIG. 2 is a functional block diagram of a system 200 for providing postage adjustment. System 200 may include several components, including a data storage 230, a payment broker 240, a payment engine 250, a postage provider 260, and a postage broker 270. Customer 110 uses computer system 120, including a PC 125 and printer 205, to connect via network 210 to postage provider 260. In the physical mail stream, POS 140 connects to postage provider 260, to provide accurate information about parcel 160.

Postage provider 260 may be associated with a delivery system operator, such as USPS™ or FedEX™. Postage provider 260 includes an application for generating mailing labels accessible via network 210. Postage provider 260 is connected to data storage 230. In some embodiments, postage provider 260 and data storage 230 are one element. Postage provider 260 may be connected to postage broker 270, either directly or through a network. Postage broker 270 creates a delivery payment code, which is the equivalent of an electronic stamp. Examples of postage broker 270 include Envelope Manager Software of Palo Alto, Calif., Neopost Online of Redwood City, Calif., and Stamps.com.

Postage provider 260 may be connected to payment engine 250, either directly or through a network. Payment engine 250 may be a communication link between postage provider 260 and payment broker 240. Payment engine 250 may be connected to payment broker 240 either directly or over a network. Payment broker 240 may perform the transaction of crediting or debiting a customer account. An example of payment broker 240 is a bank, such as First Merchant Service Bank. Data storage 230 may be used to store information about customer accounts and parcel transaction records.

POS 140 may transmit the dimension weight of parcel 160 to data storage 230 or postage provider 260 over network 210. Network 210 may comprise, for example, a local area network (LAN), a wide area network (WAN), and/or the Internet. Such networking environments are commonplace and are known by those skilled in the art.

Postage provider 260 receives the dimension weight record either from POS 140 directly or through data storage 230. The dimension weight record may be compared to the transaction record of parcel 160 stored in the data storage 230. The comparison is used to determine if the customer-determined attributes were accurate. If inaccurate, a compensation or debit amount may be calculated. Payment engine 250 and payment broker 240 may be used to facilitate the compensation or debit to customer 110.

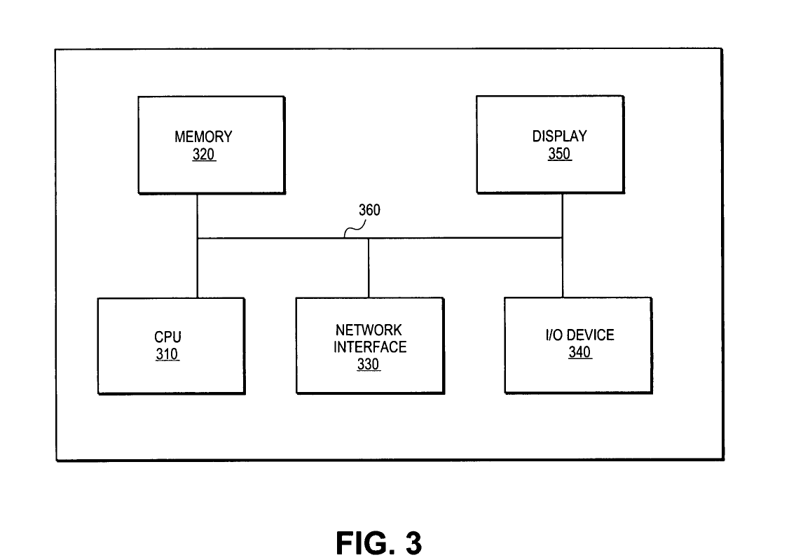

FIG. 3 is a block diagram of an exemplary computing system 300, consistent with an embodiment of the invention. Computing system 300 may represent, for example, the internal components of PC 125, POS 140, data storage 230, payment broker 240, payment engine 250, postage provider 260, and postage broker 270. By way of example, a program or set of instructions to run the postage adjustment system 200 may be implemented in computing system 300.

Computing system 300 may include a number of components, such as a processor or central processing unit (CPU) 310, a memory 320, a network interface 330, I/O devices 340, and/or a display 350. Such components may be, interconnected by a system bus 360. CPU 310 may be a microprocessor such as the Pentium® family of microprocessors manufactured by Intel Corporation. However, any other suitable microprocessor, micro-, mini-, or mainframe computer may be used, such as a micro-controller unit (MCU), or a digital signal processor (DSP).

Memory 320 may include a random access memory (RAM), a read-only memory (ROM), a video memory, mass storage, and/or cache memory such as fixed and removable media (e.g., magnetic, optical, or magnetic optical storage systems or other available mass storage technology). Memory 320 stores support modules such as, for example, a basic input/output system (BIOS), an operating system (OS), a program library, a compiler, an interpreter, and/or a text-processing tool. Support modules are commercially available and can be installed on computing system 300 by those of skill in the art. For simplicity, these modules are not illustrated. Further, memory 320 may contain an operating system, an application routine, a program, such as a web browser program, an application-programming interface (API), and/or other instructions for performing methods consistent with embodiments of the invention.

Network interface 330, examples of which include Ethernet, dial-up telephone and/or other conventional data port connections, may be used to communicate with other devices through, for example, a communication network (not shown). Computing system 300 may also receive input via input/output (I/O) devices 340, which may include a keyboard, pointing device, or other like input devices. Computing system 300 may also provide output via input/output (I/O) devices 340, which may include a printer 205. Computing system 300 may also present information and interfaces, such as an Internet application, via by display 350 to customer 110.

Bus 360 may be a bidirectional system bus. For example, bus 360 may contain thirty-two address bit lines for addressing a memory 320 and thirty-two bit lines across which data is transferred among the components. Alternatively, multiplexed data/address lines may be used instead of separate data and address lines.

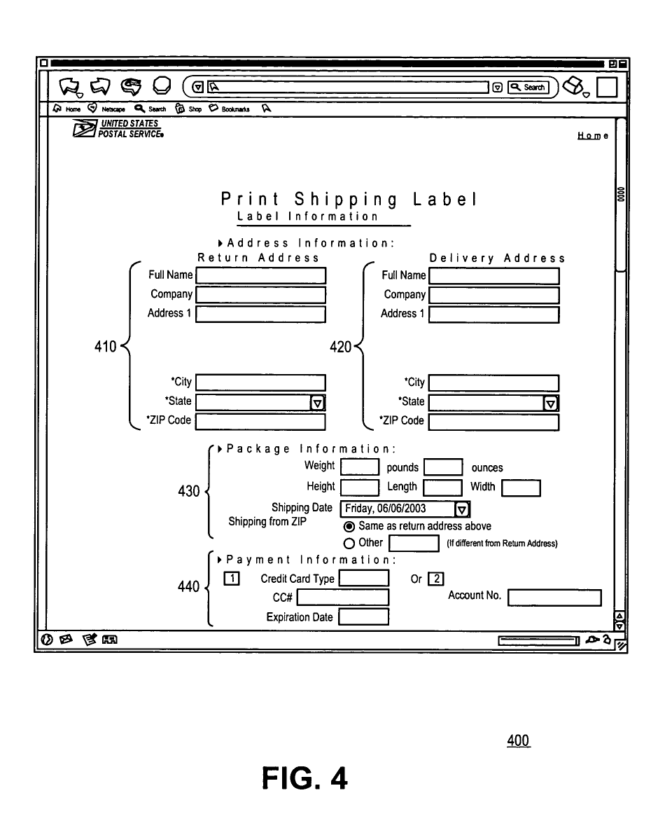

FIG. 4 is a graphical depiction of an exemplary interface of an Internet application for generating postage, as would appear on display 350 of customer system 120. To generate postage, customer 110 enter information, including return address information 410, delivery address information 420, package information 430, and payment information 440, into an Internet application of postage provider 260. Postage provider may provide this information to postage broker 270. Postage broker 270 may then embed this information in postage indicia, such as a delivery payment coding, and provide this postage indicia to postage provider 260. Postage provider 260 may use the information and the indicia to generate a mailing label with postage.

As illustrated on FIG. 4, return address information 410 may include name, company, address, city, state and zip code. The same information may also be requested in delivery address information 420. Package information 430 may include customer-determined height, length, width, and weight, along with shipping date and zip code. This information is used to determine the amount of the postage value necessary to ship parcel 160. To pay for the postage value, payment information 440 is requested. Payment information 440 may be in the form of a Credit Card Number or an account number. When customer 110 wishes to send parcel 160, customer 110 enters address, package, and payment information. Postage provider 260 may store all of the information entered in data storage 230.

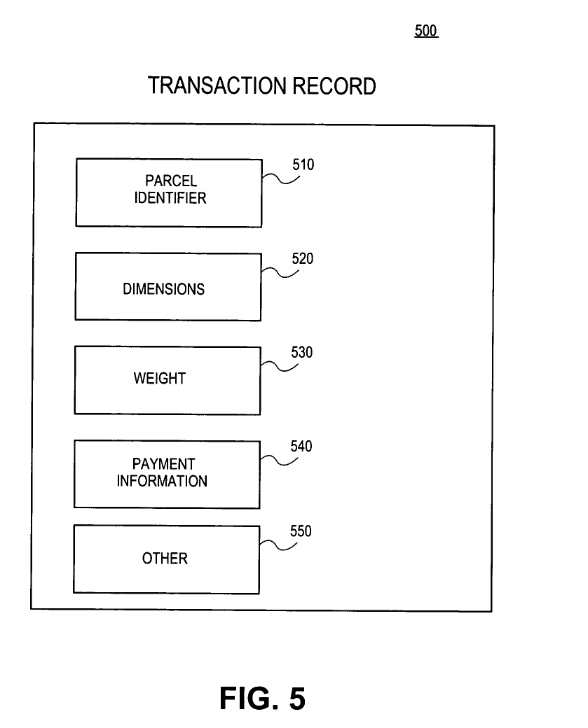

FIG. 5 is a functional block diagram of an exemplary transaction record generated by postage provider 260 as a result of customer entry. Data entered into interface 400 may be stored in data storage 230 as transaction record 500. Transaction record 500 includes parcel identifier 510, customer-entered dimensions 520, weight 530, payment information 540, and other 550. Other 550 may include the postage value and identifier calculated from the customer-determined attributes of parcel 160. When parcel 160 reaches POS 140, data stored in transaction record 500 may be used in comparisons to operator-determined values from a dimension weight record generated by POS 140.

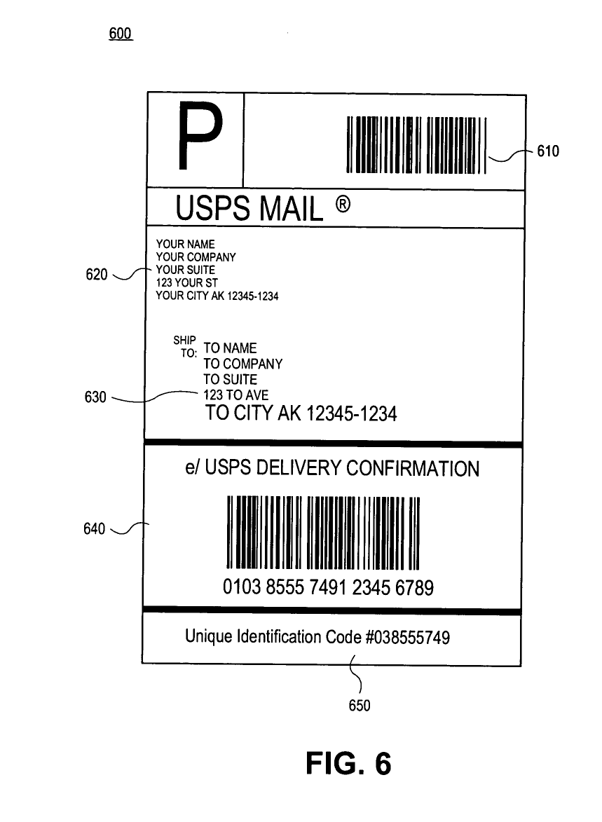

FIG. 6 is a graphical depiction of an exemplary label 600 provided by the application of postage provider 260 and printed by customer 110. Mailing label 600 may include a destination 630 of recipient and a return address 620 indicating where to return parcel 160 in case of problems with delivery. In addition, a tracking indicia 640 is placed on label 600 along with a delivery payment coding 610 and a unique identification code 650. A delivery system operator may utilize tracking indicia 640 to facilitate the delivery of item 160. Delivery payment coding 610 indicates the postage value calculated based on customer-determined attributes. Delivery payment coding 610 may comprise a bar code, an image indicating an account from which delivery payment has been made, a postage stamp, a machine-readable postage indicia indicating the amount of the received payment, or other types of coding as is known by those skilled in the art.

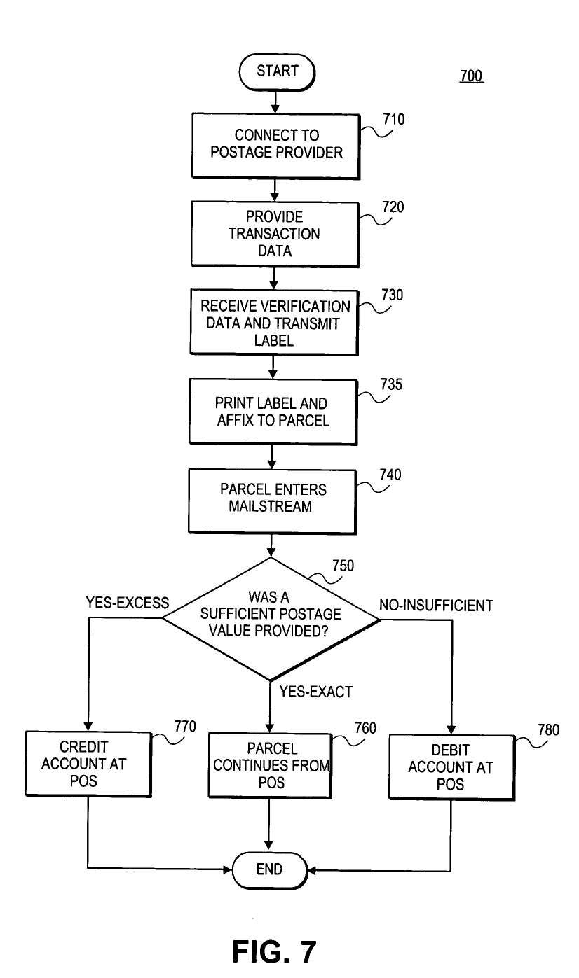

FIG. 7 is a flow chart of an exemplary method for providing postage adjustment. When customer 110 wants to ship a parcel without visiting a delivery system operator to purchase postage, customer 110 may connect to postage provider 260 via an Internet application (step 710). In one embodiment, the customer sets up an account with the postage provider or identifies himself as an existing account holder. The customer account may store payment information, such as a credit card or debit account that may be used for a shipping transaction, and return address information.

Next, the customer enters transaction data into the Internet application, such as the customer-determined or estimated weight and/or size (“dimensional weight”) of the parcel to be shipped (step 720). Customer 110 may also indicate a desire for home or office pickup.

The Internet application displays to customer 110 a postage value based on customer-determined attributes of dimension and/or weight. Payment engine 250 or payment broker 240 may calculate the postage value required based on the customer-determined attributes and provide this information to the Internet application. Payment engine 250 or payment broker 240 may also verify that sufficient funds exist in the customer account. Only after a determination of sufficient funds is the postage created and applied to the mailing label. In another embodiment, a credit card would remain open for an additional charge or credit.

If customer 110 chooses to proceed with the transaction, the customer account may be debited. If the customer does not have sufficient funds in the account or does not have an account with the postage provider, the customer may be prompted to identify a credit card to be billed.

Payment verification data is then transmitted by the delivery system operator and received by PC 125 of customer 110 to initiate printing of a mailing label 600 (step 730). Mailing label 600 may include a unique identification code 650, such as a machine readable code like a barcode, series of characters, or another detectable image, or indicator. Mailing label 600 may contain an indication of a paid postage value based on the customer-determined attributes of parcel 160. This indication may be provided by postage broker 270. Mailing label 600 is then printed and affixed to parcel 160 (step 735).

Parcel 160 is then placed in the physical mail stream, where it passes through POS 140 (step 740). At POS 140, mailing label 600 is scanned to read unique identification code 650 and parcel 160 is processed to determine the dimensions and/or weight of parcel 160. In one embodiment, postage broker 270 may verify that a unique and not duplicated postage value has been assigned to parcel 160. In one embodiment, the customer-determined attributes are stored in transaction record 500 in data storage 230. The operator-determined dimensions and/or weight is compared with the customer-determined attributes (step 750). In one embodiment, POS 140 performs a look-up and compares stored customer-determined attributes to operator-determined attributes for parcel 160. In another embodiment, postage provider 260 or a third party may perform the look-up.

In an alternate embodiment, the operator-determined dimensional weight is used to calculate a postage value. The operator-determined postage value is compared with the postage value indicated on the parcel, the postage value generated based on the customer-determined attributes. In some cases, the customer-determined attributes may be inaccurate, but a sufficient postage value may still be generated.

If the customer-determined attributes generate a sufficient postage value for parcel 160, it continues through the physical mail stream (step 760). If the customer-determined attributes generate a postage value that is greater than the operator-determined postage value, a credit may be applied to the customer's account, either as a direct repayment of the overpayment, or as a credit toward future purchases (step 770). If customer-determined attributes generate a postage value that is less than the operator-determined postage value, a debit may be made to the customer account (step 780). Thus, even if the postage value on mailing label 600 is insufficient, parcel 160 may continue without delay and without the added burden and expense of returning parcel 160 to customer 110 for additional postage. Further, the customer receives assurance that any overpayment will be credited.

In another embodiment, customer 110 pays for the transaction by credit card in the amount calculated from customer-determined attributes. Payment engine 250 delays processing the payment until after the parcel has passed though POS 140 and adjustments to the postage value have been made to correct any discrepancy between the calculated amount an the actual postage value. This provides for a single change to the credit account, and avoids multiple transaction fees levied by payment broker 240.

In another embodiment, a communications system, for example, regular mail, e-mail, facsimile, Internet, or an interactive voice response telephone system, is utilized to inform customer 110 of an additional charge or credit. An image of parcel 160 may be included along with the information about the adjustment to the postage value.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to computer-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. For example, the steps of the exemplary methods of FIG. 7 may be modified, substituted, deleted or re-ordered as needed. Further, additional steps may be added to the exemplary methods without departing from the scope of the embodiments of the invention. Therefore, it is intended that the specification and examples be considered as exemplary only, with a true scope and spirit of the invention being indicated by the following claims.

1. A method for receiving payment for postage for a parcel by a delivery system operator from a customer, comprising:
receiving payment from the customer for a first postage value;
receiving the parcel for delivery, the parcel including a machine-readable postage indicia indicating the amount of the received payment;
determining parcel attributes;
calculating a determined postage value for the parcel based on the determined parcel attributes;
determining the first postage value from the indicia; and
transmitting a postage payment adjustment amount based on a comparison between the first postage value and the determined postage value.

2. The method of claim 1 wherein the payment is received from the customer over a network.

3. The method of claim 2 wherein the payment is received by the delivery system operator over the Internet.

4. The method of claim 1 wherein the machine-readable postage indicia is one of a bar code and an image indicating an account from which delivery payment has been made.

5. The method of claim 1 wherein adjusting the payment further comprises:
requesting additional payment when the determined postage value is greater then the first postage value.

6. The method of claim 1 wherein adjusting the payment further comprises:
generating a credit when the determined postage value is less then the first postage value.

7. The method of claim 1 wherein the parcel is at least one of the following: a mailpiece, a package, an oversized package, a United States Postal Service Priority Mail package, and a United States Postal Service Express Mail Package.

8. The method of claim 1 wherein transmitting a postage payment adjustment amount comprises transmitting data by at least one of regular mail, e-mail, facsimile, internet, and an interactive voice response system.

9. A system for receiving payment for postage for a parcel by a delivery system operator from a customer, comprising:
a payment receiving component to receive payment from the customer for a first postage value;
a parcel receiving component to receive the parcel for delivery, the parcel including a machine-readable postage indicia indicating the amount of the received payment;
a parcel determining component to determine parcel attributes;
a calculating component to calculate a determined postage value for the parcel based on the determined parcel attributes;
a postage determining component to determine the first postage value from the indicia; and
a transmitting component to transmit a postage payment adjustment amount based on a comparison between the first postage value and the determined postage value.

10. The system of claim 9 wherein the payment receiving component receives payment from the customer over a network.

11. The system of claim 10 wherein the payment receiving component receives payment by the delivery system operator over the Internet.

12. The system of claim 9 wherein the machine-readable postage indicia is one of a bar code and an image indicating an account from which delivery payment has been made.

13. The system of claim 9 wherein adjusting the payment further comprises:
a requesting component to request additional payment when the determined postage value is greater then the first postage value.

14. The system of claim 9 wherein adjusting the payment further comprises:
a generating component to generate a credit when the determined postage value is less then the first postage value.

15. The system of claim 9 wherein the parcel is at least one of the following: a mailpiece, a package, an oversized package, a United States Postal Service Priority Mail package, and a United States Postal Service Express Mail Package.

16. The system of claim 9 wherein the transmitting component to transmit a postage payment adjustment amount comprises transmitting data by at least one of regular mail, e-mail, facsimile, Internet, and an interactive voice response system.

17. A system for receiving payment for postage for a parcel by a delivery system operator from a customer, comprising:
means for receiving payment from the customer for a first postage value;
means for receiving the parcel for delivery, the parcel including a machine-readable postage indicia indicating the amount of the received payment;
means for determining parcel attributes;
means for calculating a determined postage value for the parcel based on the determined parcel attributes;
means for determining the first postage value from the indicia; and
means for transmitting a postage payment adjustment amount based on a comparison between the first postage value and the determined postage value.

18. The system of claim 17 wherein the means for receiving payment is from the customer over a network.

19. The system of claim 18 wherein the means for receiving payment is by the delivery system operator over the Internet.

20. The system of claim 17 wherein the machine-readable postage indicia is one of a bar code and an image indicating an account from which delivery payment has been made.

21. The system of claim 17 wherein the means for adjusting the payment further comprises:
means for requesting additional payment when the determined postage value is greater then the first postage value.

22. The system of claim 17 wherein the means for adjusting the payment further comprises:
means for generating a credit when the determined postage value is less then the first postage value.

23. The system of claim 17 wherein the parcel is at least one of the following: a mailpiece, a package, an oversized package, a United States Postal Service Priority Mail package, and a United States Postal Service Express Mail Package.

24. The system of claim 17 wherein the means for transmitting a postage payment adjustment amount comprises transmitting data by at least one of regular mail, e-mail, facsimile, Internet, and an interactive voice response system.

25. A computer-readable medium containing instructions for controlling a data processing system to perform a method for receiving payment for postage for a parcel by a delivery system operator from a customer, the method comprising the steps of:
receiving payment from the customer for a first postage value;
receiving the parcel for delivery, the parcel including a machine-readable postage indicia indicating the amount of the received payment;
determining parcel attributes;
calculating a determined postage value for the parcel based on the determined parcel attributes;
determining the first postage value from the indicia; and
transmitting a postage payment adjustment amount based on a comparison between the first postage value and the determined postage value.

26. The computer-readable medium of claim 25 wherein the payment is received from the customer over a network.

27. The computer-readable medium of claim 26 wherein the payment is received by the delivery system operator over the Internet.

28. The computer-readable medium of claim 25 wherein the machine-readable postage indicia is one of a bar code and an image indicating an account from which delivery payment has been made.

29. The computer-readable medium of claim 25 wherein adjusting the payment further comprises:
requesting additional payment when the determined postage value is greater then the first postage value.

30. The computer-readable medium of claim 25 wherein adjusting the payment further comprises:
generating a credit when the determined postage value is less then the first postage value.

31. The computer-readable medium of claim 25 wherein the parcel is at least one of the following: a mailpiece, a package, an oversized package, a United States Postal Service Priority Mail package, and a United States Postal Service Express Mail Package.

32. The computer-readable medium of claim 25 wherein transmitting a postage payment adjustment amount comprises transmitting data by at least one of regular mail, e-mail, facsimile, Internet, and an interactive voice response system.

33. A method for receiving payment for postage by a delivery system operator from a customer, comprising:
receiving from the customer mailing information for a parcel, the mailing information comprising customer-determined attributes of the parcel;
calculating a first postage value based on the customer-determined attributes;
transmitting data to the customer to permit printing by the customer of a mailing label for the parcel, the mailing label including an indication of the first postage value;
charging a customer account for the first postage value;
determining attributes of the parcel by the delivery system operator;
calculating a second postage value for the parcel based on the operator-determined attributes; and
transmitting a postage payment adjustment amount to the customer account based on a comparison between the first and second postage values.

34. The method of claim 33 wherein the mailing information is received from the customer over a network.

35. The method of claim 34 wherein the mailing information is received by the delivery system operator over the Internet.

36. The method of claim 33 wherein the customer-determined attributes include at least one of height, length, weight, thickness, and weight of the parcel.

37. The method of claim 36 wherein the mailing information comprises at least one of return address information, destination address information, and payment information.

38. The method of claim 33 wherein the mailing information comprises at least one of return address information, destination address information, and payment information.

39. The method of claim 33 further comprising storing the mailing information.

40. The method of claim 33 wherein the customer account is a credit card account.

41. The method of claim 33 wherein the mailing label further comprises a unique identification code for the parcel.

42. The method of claim 33 wherein obtaining operator-determined attributes comprises at least one of weighing the parcel, capturing an image of the parcel, and sensing physical dimensions of the parcel.

43. The method of claim 33 wherein adjusting the payment further comprises:
requesting additional payment when the second postage value is greater then the first postage value.

44. The method of claim 33 wherein adjusting the payment further comprises:
generating a credit when the second postage value is less then the first postage value.

45. The method of claim 33 wherein the indication of the first postage value is at least one of a bar code, an image indicating an account from which delivery payment has been made, and a postage stamp.

46. The method of claim 33 wherein the parcel is at least one of the following: a mailpiece, a package, an oversized package, a United States Postal Service Priority Mail package, and a United States Postal Service Express Mail Package.

47. The method of claim 33 wherein transmitting a postage payment adjustment amount comprises transmitting data by at least one of regular mail, e-mail, facsimile, internet, and an interactive voice response system.

48. A method for correcting a postage value, comprising:
storing a first postage value derived from customer-determined attributes of a parcel;
receiving payment for the first postage value;
receiving the parcel at a delivery system operator;
determining attributes of the parcel by the delivery system operator to generate a second postage value;
comparing the first and second postage values; and
if the first postage value is greater then the second postage value, providing a credit to the customer; and
if the second postage value is less then the first postage value, generating a charge to the customer.

49. A system for receiving payment for postage by a delivery service operator from a customer, comprising:
a first component to receive from the customer mailing information for a parcel, the mailing information comprising customer-determined attributes of the parcel;
a second component to calculate a first postage value based on the customer-determined attributes;
a third component to transmit data to the customer to permit printing by the customer of a mailing label for the parcel, the mailing label including an indication of the first postage value;
a fourth component to charge a customer account for the first postage value;
a fifth component to determine attributes of the parcel by the delivery system operator;
a sixth component to calculate a second postage value for the parcel based on the operator-determined attributes; and
a seventh component to transmit a postage payment adjustment amount to the customer account based on a comparison between the first and second postage values.

50. The system of claim 49 wherein the first component is a network interface component to receive mailing information from the customer over a network.

51. The system of claim 50 wherein the first component is a network interface component to receive mailing information by the delivery system operator over the Internet.

52. The system of claim 49 wherein the customer-determined attributes include at least one of height, length, weight, thickness, and weight of the parcel.

53. The system of claim 52 wherein the mailing information comprises at least one of return address information, destination address information, and payment information.

54. The system of claim 49 wherein the mailing information comprises at least one of return address information, destination address information, and payment information.

55. The system of claim 49 further comprising an eighth component to store the mailing information.

56. The system of claim 49 wherein the customer account is a credit card account.

57. The system of claim 49 wherein the mailing label further comprises a unique identification code for the parcel.

58. The system of claim 49 wherein the fifth component comprises at least one of a weight component to weigh the parcel, a capture component to capture an image of the parcel, and a sensing component to sense physical dimensions of the parcel.

59. The system of claim 49 wherein the seventh component further comprises:
a requesting component to request additional payment when the second postage value is greater then the first postage value.

60. The system of claim 49 wherein the seventh component further comprises:
a generating component to generate a credit when the second postage value is less then the first postage value.

61. The system of claim 49 wherein the indication of the first postage value is at least one of a bar code, an image indicating an account from which delivery payment has been made, and a postage stamp.

62. The system of claim 49 wherein the parcel is at least one of the following: a mailpiece, a package, an oversized package, a United States Postal Service Priority Mail package, and a United States Postal Service Express Mail Package.

63. The system of claim 49 wherein the seventh component comprises a transmitting component to transmit data by at least one of regular mail, e-mail, facsimile, internet, and an interactive voice response system.

64. A system for correcting a postage value, comprising:
a first component to store a first postage value derived from customer-determined attributes of a parcel;
a second component to receive payment for the first postage value;
a third component to receive the parcel at a delivery-system operator;
a fourth component to determine attributes of the parcel by the delivery system operator to generate a second postage value;
a fifth component to compare the first and second postage values; and
if the first postage value is greater then the second postage value, providing a credit to the customer; and
if the second postage value is less then the first postage value, generating a charge to the customer.

65. A method for receiving payment for postage by a delivery system operator from a customer, comprising:
means for receiving from the customer mailing information for a parcel, the mailing information comprising customer-determined attributes of the parcel;
means for calculating a first postage value based on the customer-determined attributes;
means for transmitting data to the customer to permit printing by the customer of a mailing label for the parcel, the mailing label including an indication of the first postage value;
means for charging a customer account for the first postage value;
means for determining attributes of the parcel by the delivery system operator;
means for calculating a second postage value for the parcel based on the operator-determined attributes; and
means for transmitting a postage payment adjustment amount to the customer account based on a comparison between the first and second postage values.

66. The system of claim 65 wherein the means for receiving comprises means for receiving the mailing information from the customer over a network.

67. The system of claim 65 wherein the means for receiving comprises means for receiving the mailing information by the delivery system operator over the Internet.

68. The system of claim 65 wherein the customer-determined attributes comprise at least one of height, length, weight, thickness, and weight of the parcel.

69. The system of claim 68 wherein the mailing information comprises at least one of return address information, destination address information, and payment information.

70. The system of claim 65 wherein the mailing information comprises at least one of return address information, destination address information, and payment information.

71. The system of claim 65 further comprising means for storing the mailing information.

72. The system of claim 65 wherein the customer account is a credit card account.

73. The system of claim 65 wherein the mailing label further comprises a unique identification code for the parcel.

74. The system of claim 65 wherein the means for determining attributes by the delivery system operator comprises means for at least one of weighing the parcel, capturing an image of the parcel, and sensing physical dimensions of the parcel.

75. The system of claim 65 wherein the means for adjusting the payment further comprises:
means for requesting additional payment when the second postage value is greater then the first postage value.

76. The system of claim 65 wherein the means for adjusting the payment further comprises:
means for generating a credit when the second postage value is less then the first postage value.

77. The system of claim 65 wherein the indication of the first postage value is at least one of a bar code, an image indicating an account from which delivery payment has been made, and a postage stamp.

78. The system of claim 65 wherein the parcel is at least one of: a mailpiece, a package, an oversized package, a United States Postal Service Priority Mail package, and a United States Postal Service Express Mail Package.

79. The system of claim 65 wherein the means for transmitting a postage payment adjustment amount comprises means for transmitting data by at least one of regular mail, e-mail, facsimile, internet, and an interactive voice response system.

80. The system for correcting a postage value, comprising:
means for storing a first postage value derived from customer-determined attributes of a parcel;
means for receiving payment for the first postage value;
means for receiving the parcel at a delivery-system operator;
means for determining attributes of the parcel by the delivery system operator to generate a second postage value; and
means for comparing the first and second postage values for providing a credit to the customer if the first postage value is greater then the second postage value and generating a charge to the customer if the second postage value is less then the first postage value.

81. A computer-readable medium containing instructions for controlling a data processing system to perform a method for receiving payment for postage by a delivery system operator from a customer, the method comprising the steps of:
calculating a first postage value based on customer-determined attributes contained in mailing information for a parcel received from the customer;
transmitting data to the customer to permit printing by the customer of a mailing label for the parcel, the mailing label including an indication of the first postage value;
charging a customer account for the first postage value;
calculating a second postage value for the parcel based on attributes of the parcel determined by the delivery system operator; and
transmitting a postage payment adjustment amount to the customer account based on a comparison between the first and second postage values.

82. The computer-readable medium of claim 81 wherein the mailing information is received from the customer over a network.

83. The computer-readable medium of claim 81 wherein the mailing information is received by the delivery system operator over the Internet.

84. The computer-readable medium of claim 81 wherein the customer-determined attributes include at least one of height, length, weight, thickness, and weight of the parcel.

85. The computer-readable medium of claim 81 wherein the mailing information comprises at least one of return address information, destination address information, and payment information.

86. The computer-readable medium of claim 81 wherein the mailing information comprises at least one of return address information, destination address information, and payment information.

87. The computer-readable medium of claim 81 wherein the customer account is a credit card account.

88. The computer-readable medium of claim 81 wherein the mailing label further comprises a unique identification code for the parcel.

89. The computer-readable medium of claim 81 wherein obtaining actual attributes comprises at least one of weighing the parcel, capturing an image of the parcel, and sensing physical dimensions of the parcel.

90. The computer-readable medium of claim 81 wherein adjusting the payment further comprises:
requesting additional payment when the second postage value is greater then the first postage value.

91. The computer-readable medium of claim 81 wherein adjusting the payment further comprises:
generating a credit when the second postage value is less then the first postage value.

92. The computer-readable medium of claim 81 wherein the indication of the first postage value is at least one of a bar code, an image indicating an account from which delivery payment has been made, and a postage stamp.

93. The computer-readable medium of claim 81 wherein in the parcel is at least one of the following: a mailpiece, a package, an oversized package, a United States Postal Service Priority Mail package, and a United States Postal Service Express Mail Package.

94. The computer-readable medium of claim 81 wherein transmitting a postage payment adjustment amount comprises transmitting data by at least one of regular mail, e-mail, facsimile, internet, and an interactive voice response system.

95. A computer-readable medium containing instructions for controlling a data processing system to perform a method for correcting a postage value, said method comprising the steps of:
storing a first postage value derived from customer-determined attributes of a parcel;
receiving payment for the first postage value;
generating a second postage value based on attributes of the parcel determined by the delivery system operator;
comparing the first and second postage values;
providing a credit to the customer if the first postage value is greater then the second postage value; and
generating a charge to the customer if the second postage value is less then the first postage value.

96. A system for correcting a postage value, comprising:
a memory having program instructions; and
a processor responsive to the program instructions to: store a first postage value derived from customer-determined attributes of a parcel; receive payment for the first postage value; generate a second postage value based on attributes of the parcel determined by the delivery system operator; compare the first and second postage values; provide a credit to the customer if the first postage value is greater then the second postage value; and generate a charge to the customer if the second postage value is less then the first postage value.
